(19) United States
(12) Patent Application Publication
(10) Pub. No.: US 2011/0147547 A1
(43) Pub. Date: Jun. 23, 2011

(54) FOLDABLE STAND

(75) Inventors: Garett Fitzpatrick, Brier, WA (US); Morgan E. Featherstone, Everett, WA (US)

(73) Assignee: CRANE HARDWARE LLC, Everett, WA (US)

(21) Appl. No.: 12/886,495

(22) Filed: Sep. 20, 2010

Related U.S. Application Data
(60) Provisional application No. 61/243,958, filed on Sep. 18, 2009.

(51) Int. Cl. F16M 11/26; F16M 11/38

(52) U.S. Cl. 248/157; 248/188.6

(57) ABSTRACT

A stand is provided that is foldable or collapsible between one or more erect positions and a folded or collapsed position. This allows the stand to provide the user with several ergonomic positions for supporting a laptop, book, etc, during use, and then subsequently allows the stand to fold or collapse into a compact configuration for storage, transport, etc.

### CROSS-REFERENCE(S) TO RELATED APPLICATION

The present application claims the benefit of U.S. Provisional Application No. 61/243,958, filed Sep. 18, 2009, the disclosure of which is expressly incorporated by reference.

### BACKGROUND

Laptop computers have become very popular and widely used for both business and personal activities. Laptop computers are typically single, integrated units housed in a single compact case to enhance their portability. Laptop computers generally include a keyboard portion movably attached to a display portion. The idea of the laptop computer, originally called “portable computer,” was meant to be positioned on a desktop, but be portable for the benefit of a user. However, such desktops are typically not designed to be portable, thereby necessitating a desktop at each location for supporting the laptop. This may prove rather inconvenient as laptops are continually being used in many settings that may not lend itself to having a desktop.

Therefore, there is a need in the industry for a portable stand, such as a laptop stand.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present invention, a foldable stand having a folded position and at least one erect position is provided. The stand includes at least one support post having opposed ends, a support defining a support surface, the support being pivotally coupled to the at least one support post at one end; and a base pivotally coupled to the at least one support post at the end opposite of the tray.

In accordance with another embodiment, a foldable stand is provided. The stand includes a support surface, a base, at least one support post, means for pivotally coupling the at least one support post to the base, and means for pivotally coupling the support surface to the at least one support post.

In accordance with another embodiment, a foldable stand is provided. The stand includes a support surface, a base, and at least one support post pivotally coupled to the base and the support surface in a selectively adjustable manner.

In accordance with another embodiment, a foldable stand is provided. The stand includes a support surface, a base, at least one support post; means for pivotally coupling the at least one support post to the base, and means for pivotally coupling the at least one support post and the support surface in a selectively adjustable manner.

In accordance with another embodiment, a foldable stand is provided. The stand includes a support surface, a base, at least one support post, means for pivotally coupling the at least one support post to the base in a selectively adjustable manner, and means for pivotally coupling the at least one support post and the support surface.

In accordance with another embodiment, a foldable stand is provided. The stand includes a support surface, a base, at least one support post; means for pivotally coupling the at least one support post to the base in a selectively adjustable manner, and means for pivotally coupling the at least support post and the support surface in a selectively adjustable manner.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a rear perspective view of one example of a foldable stand formed in accordance with aspects of the present disclosure, the foldable stand shown in the erect position;

FIG. 2 is a front perspective view of the foldable stand of FIG. 1;

FIG. 3 is a rear perspective view of the foldable stand of FIG. 1 shown in the folded or collapsed position;

FIG. 4 is a front perspective view of the foldable stand of FIG. 1 shown in the folded or collapsed position;

FIG. 5 is an exploded, rear perspective view of the foldable stand of FIG. 1;

FIG. 6 is an end view of one example of the lower cylindrical rod formed in accordance with aspects of the present invention;

FIG. 7 is an end view of one example of the upper cylindrical rod formed in accordance with aspects of the present invention;

FIGS. 8-10 are partial, front perspective views of three examples of fixed positions of the tray;

FIG. 11 is a partial, rear perspective view of the tray telescopingly extended from at least one support post in accordance with one embodiment of the present disclosure;

FIG. 12 is a partial, rear perspective view of the tray moved from one telescopingly extended position shown in FIG. 11 to a non-telescopingly extended position;

FIG. 13 is a front perspective view of another example of a foldable stand formed in accordance with aspects of the present disclosure, the foldable stand shown in the erect position;

FIGS. 14-16 are side views of one example of the foldable stand of FIG. 1 transitioning from the erect position to the folded or collapsed position;

FIG. 17 is a rear perspective view of another example of a foldable stand formed in accordance with aspects of the present disclosure, the foldable stand shown in the erect position;

FIG. 18 is a front perspective view of the foldable stand of FIG. 13;

FIG. 19 is a front perspective view of the foldable stand of FIG. 17 shown in the folded or collapsed position;

FIG. 20 is a bottom perspective view of the foldable stand of FIG. 17 shown in the folded or collapsed position;

FIG. 21 is an exploded, front perspective view of the foldable stand of FIG. 13;

FIG. 22 is a partial cross-sectional view of the adjustment mechanism with the tray removed for ease of illustration, wherein the lever is in the unlocked position;

FIG. 23 is a partial cross-sectional view of the adjustment mechanism of FIG. 22 wherein the lever is in the locked position.

FIG. 24 is a partial enlarged side view of a clamping interface between components of the foldable stand;

FIG. 25 is a rear perspective view of a foldable stand showing a new design;

FIG. 26 is a rear view of the foldable stand of FIG. 25;

FIG. 27 is a front view of the foldable stand of FIG. 25;

FIG. 28 is a side view of the foldable stand of FIG. 25;

FIG. 29 is a side view of the foldable stand of FIG. 25 taken from the side opposite from FIG. 28;

FIG. 30 is a top view of the foldable stand of FIG. 25; and

FIG. 31 is a bottom view of the foldable stand of FIG. 25.

### DETAILED DESCRIPTION

The detailed description set forth below in connection with the appended drawings is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the invention to the precise forms disclosed. Similarly, any steps described herein may be interchangeable with other steps, or combinations of steps, in order to achieve the same or substantially similar result.

The following discussion proceeds with reference to several examples of foldable or collapsible stands that are suitable for supporting, for example, laptop or notebook style computers or the like. While the examples provided herein have been described with reference to their association with laptop or notebook style computers, it will be apparent to one skilled in the art that this is done for illustrative purposes only and should not be construed as limiting the scope of the invention, as claimed. Thus, it will be apparent to one skilled in the art that aspects of the present disclosure may be utilized with other items (e.g., food, books, games, etc.) in need of support while the user is in either a sitting or a standing position. Further, it will be appreciated that embodiments of the present disclosure may employ any combination of features described herein.

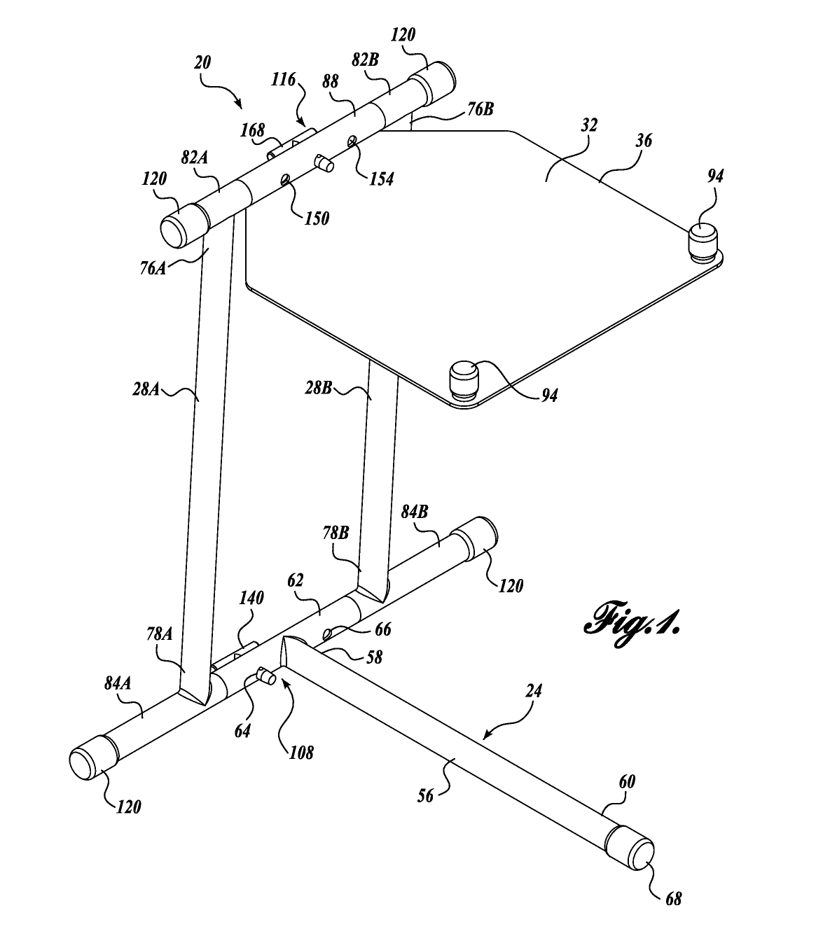

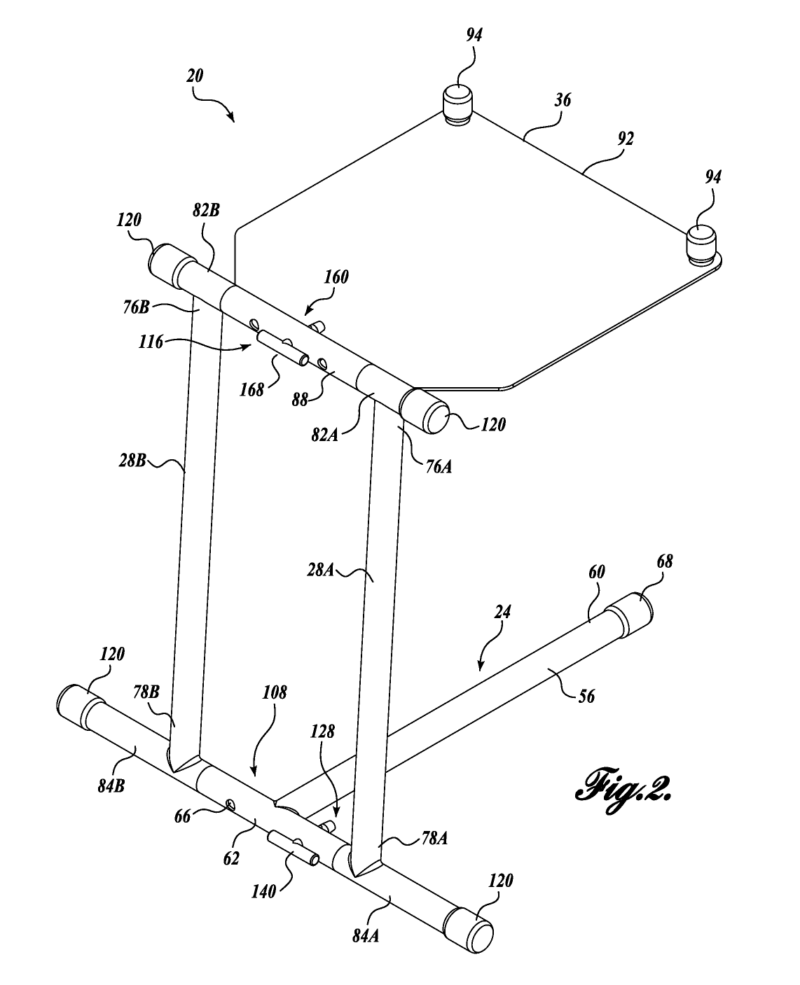

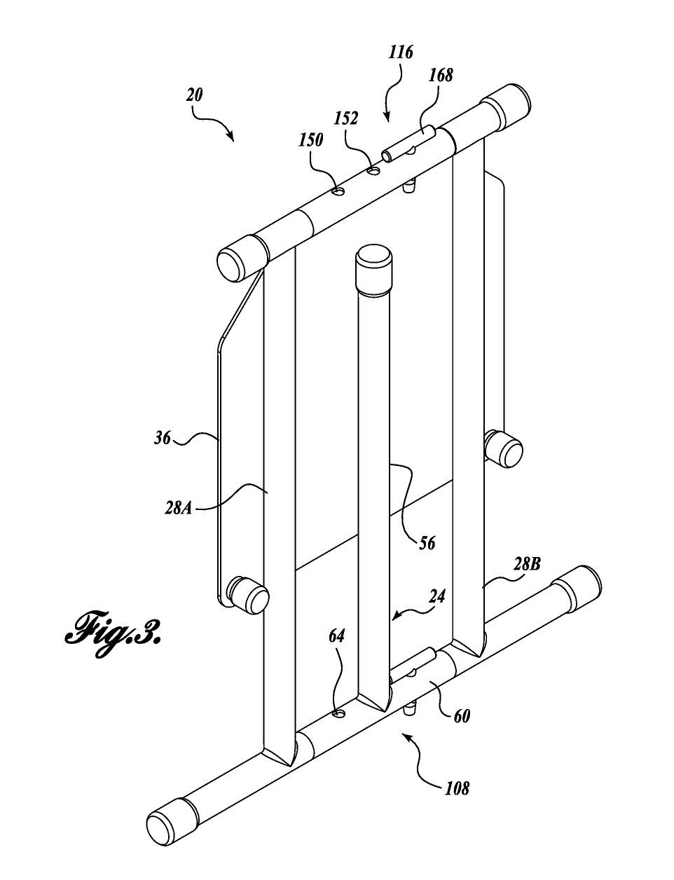

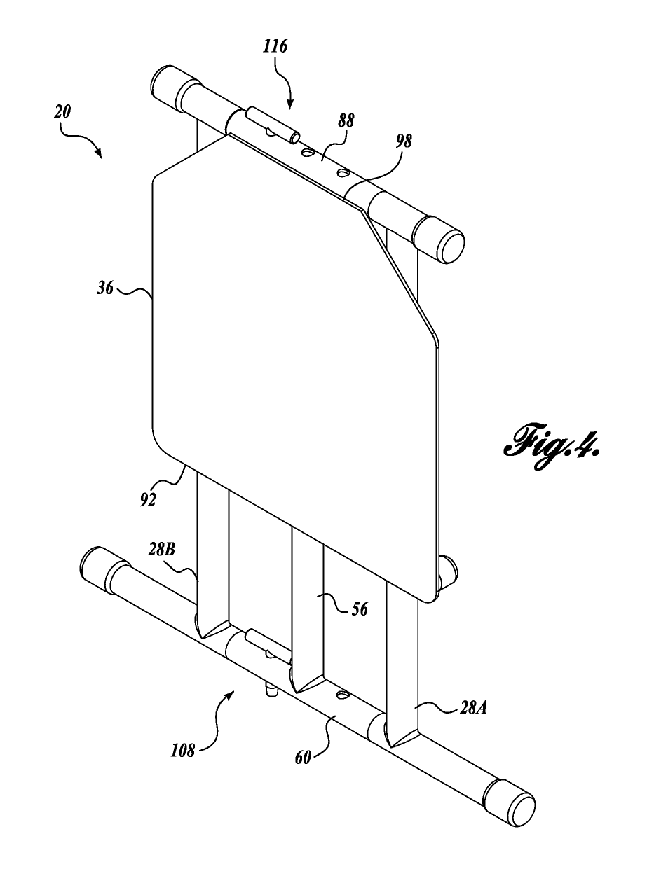

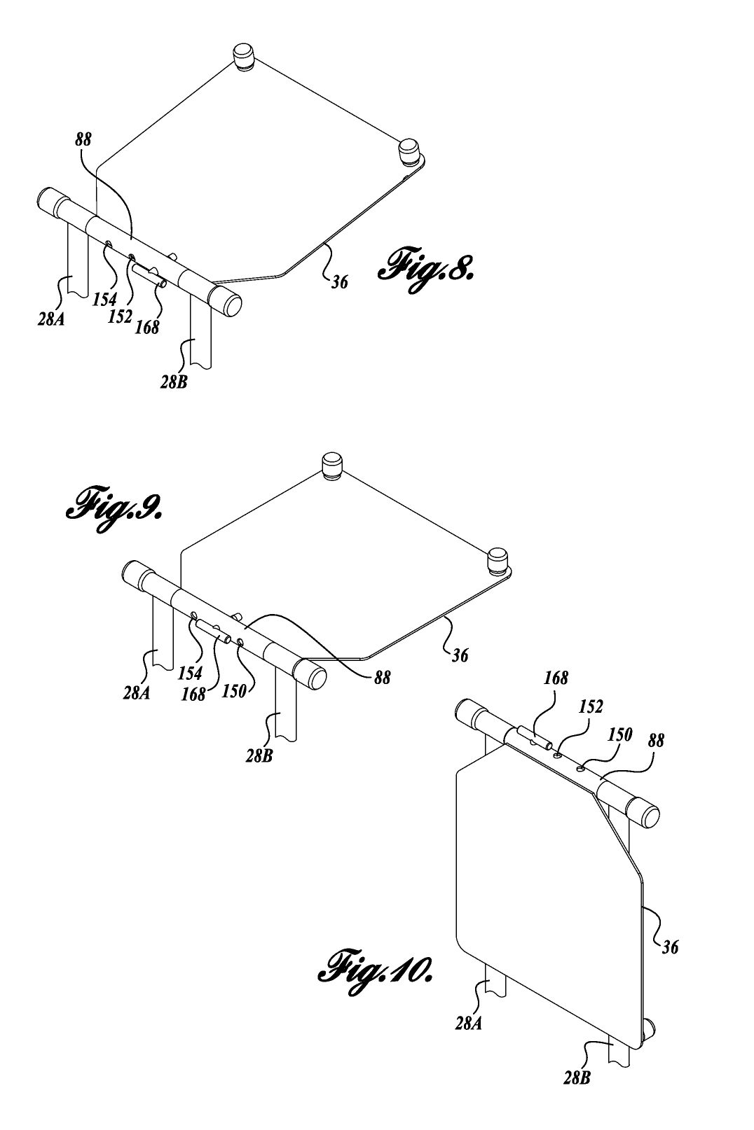

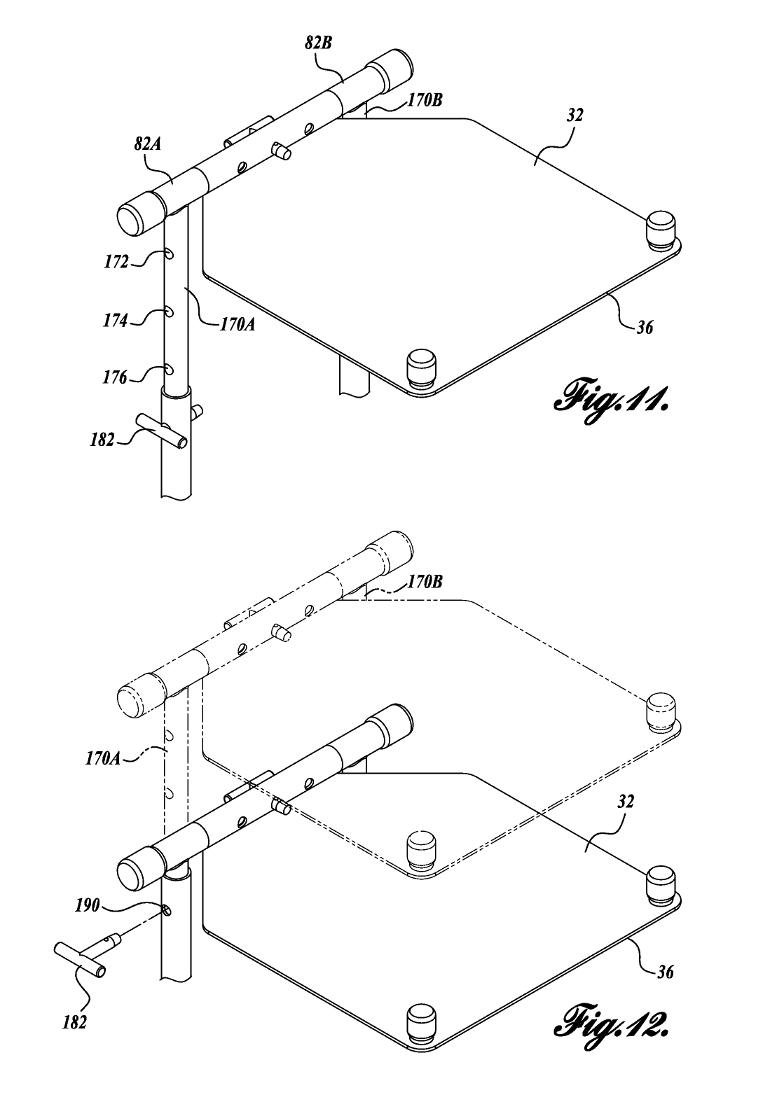

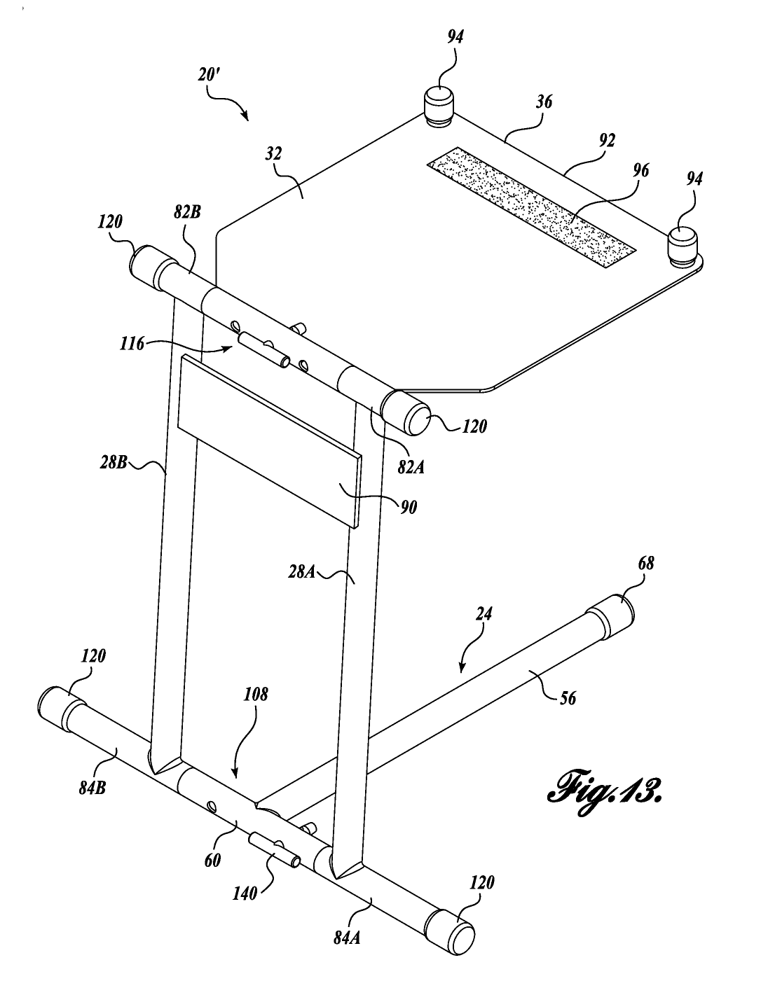

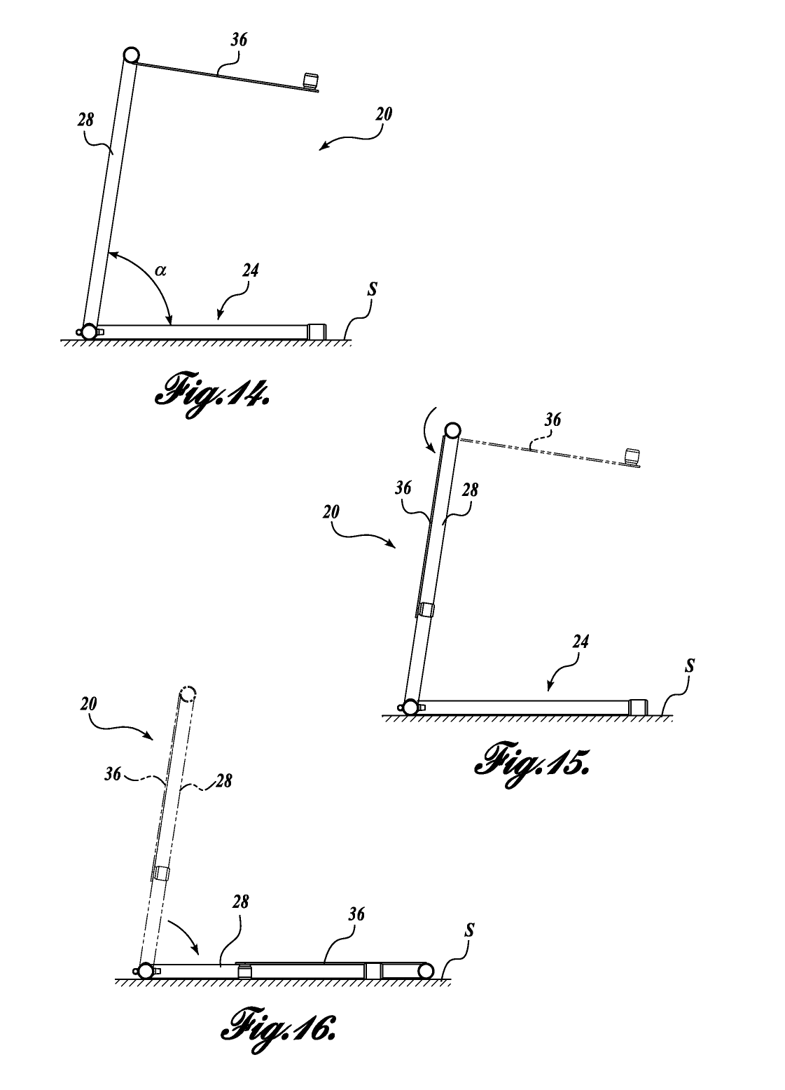

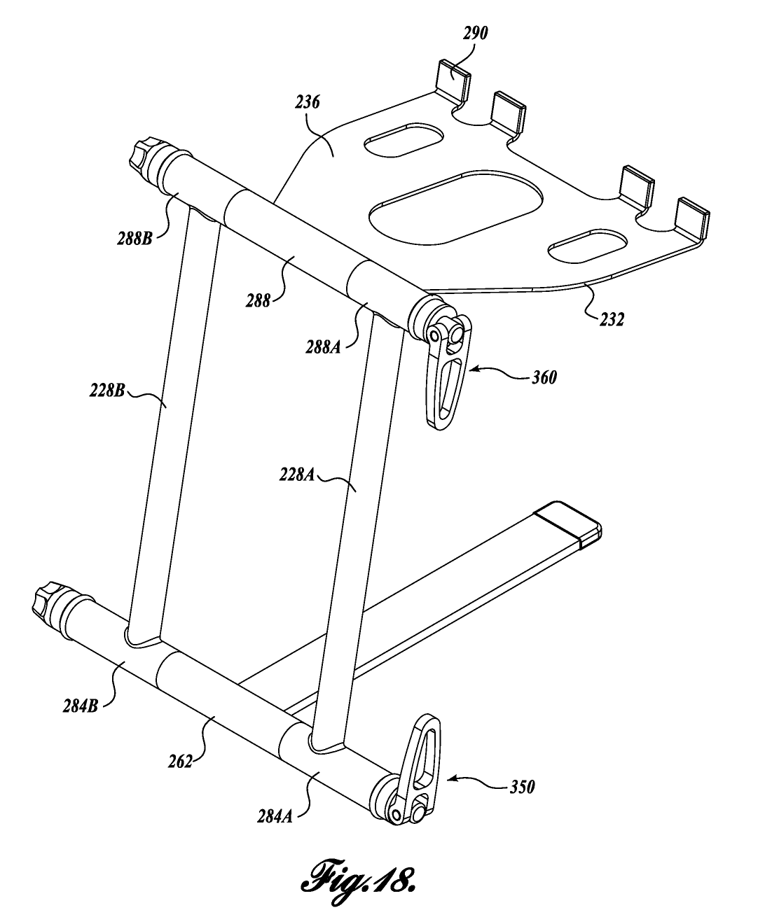

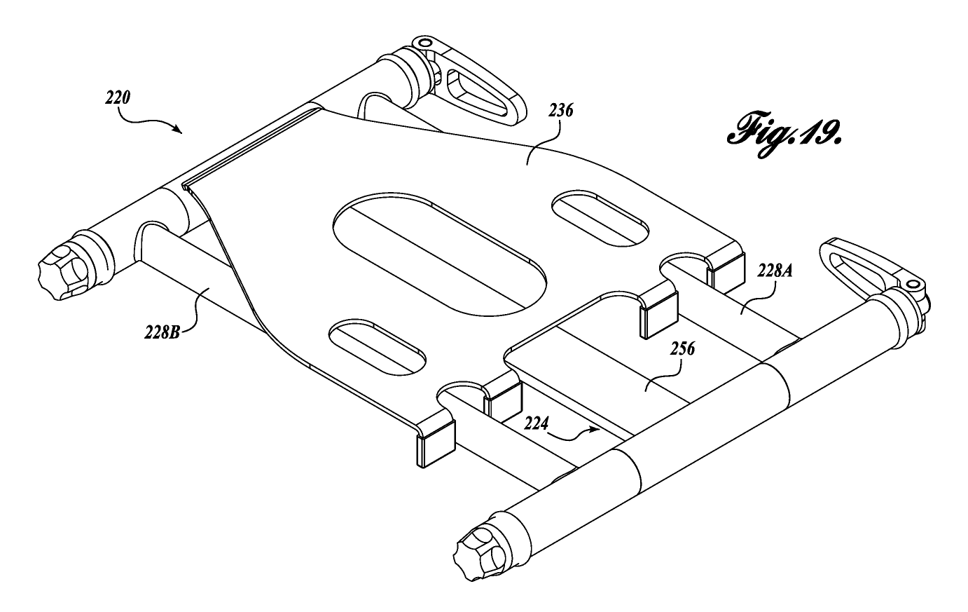

Turning now to FIGS. 1-4, there is shown one example of a foldable or collapsible support stand, such as a laptop stand 20 (“stand 20”), formed in accordance with aspects of the present disclosure. Generally described, the stand 20 is foldable or collapsible between one or more erect positions and a folded or collapsed position. This allows the stand 20 to provide the user with several ergonomic positions for supporting a laptop, book, etc, during use, and then subsequently allows the stand 20 to fold or collapse into a compact configuration for storage, transport, etc. For example, in the folded position best shown in FIGS. 3 and 4, the stand 20 can be easily carried between various locations as well as stowed in various storage locations. In one example of the erect position shown in FIGS. 1 and 2, the stand 20 is capable of supporting an object, such as a laptop computer, book, etc., at an elevated position with respect to a surface S (see FIGS. 14-16), such as a table, desk, floor and the like. In several embodiments, the stand 20 is capable of supporting an object in a number of selectively adjustable positions with respect to the surface S, as best shown in FIGS. 8-10. In other embodiments, the stand 20 is additionally or alternatively capable of supporting an object at a number of selectively adjustable elevations above the associated surface S, as best shown in FIGS. 11 and 12.

In the embodiment shown in FIGS. 1-5, the stand 20 comprises, in general, a base 24 that rests on the floor, table, etc., at least one support post 28 (shown, for example, as two support posts 28A and 28B), and a support surface 32 defined by a tray 36 or the like. As will be described in more detail below, the base 24 is pivotally coupled to the at least one support post 28, and is movable between a number of fixed positions in a selectively adjustable manner. Similarly, the tray 36 is pivotally coupled to the at least one support post 28, and is movable between a number of fixed positions in a selectively adjustable manner. As best shown in FIGS. 11 and 12, the tray 36 in one embodiment may also telescopically extend from the at least one support post 28 between a number of fixed positions in a selectively adjustable manner so as to alter the height of the support surface 132 with respect to the floor, table, etc.

Prior to describing the components in detail, it will be appreciated that the components may be constructed out of a lightweight and rigid material, such as steel, aluminum, etc., wood, and some engineered plastics or the like.

Turning now to FIGS. 1-5, the components of the stand 20 will now be described in detail. As best shown in FIGS. 1, 2, and 5, the base 24 in one embodiment is formed by a leg 56 having a frontward end 58 and a rearward end 60. Coupled to the frontward end 58 of the leg 56 in an orthogonal manner is a cross member section 62, thereby forming a T-shaped member. In the embodiment shown, the cross member section 62 is tubular in shape and includes at least two pairs of aligned holes 64 and 66, for reasons for which will be described in more detail below. Similar to the cross member section 62, in the embodiment shown, the leg 56 is tubular in shape. In one embodiment, a cap 68 or the like may be optionally coupled to the rearward end 60 of the leg 56 for aesthetical purposes and/or to prevent dirt, debris and the like from entering the interior of the leg 56. In other embodiments, the leg 56 may have other configurations, cross sections, etc.

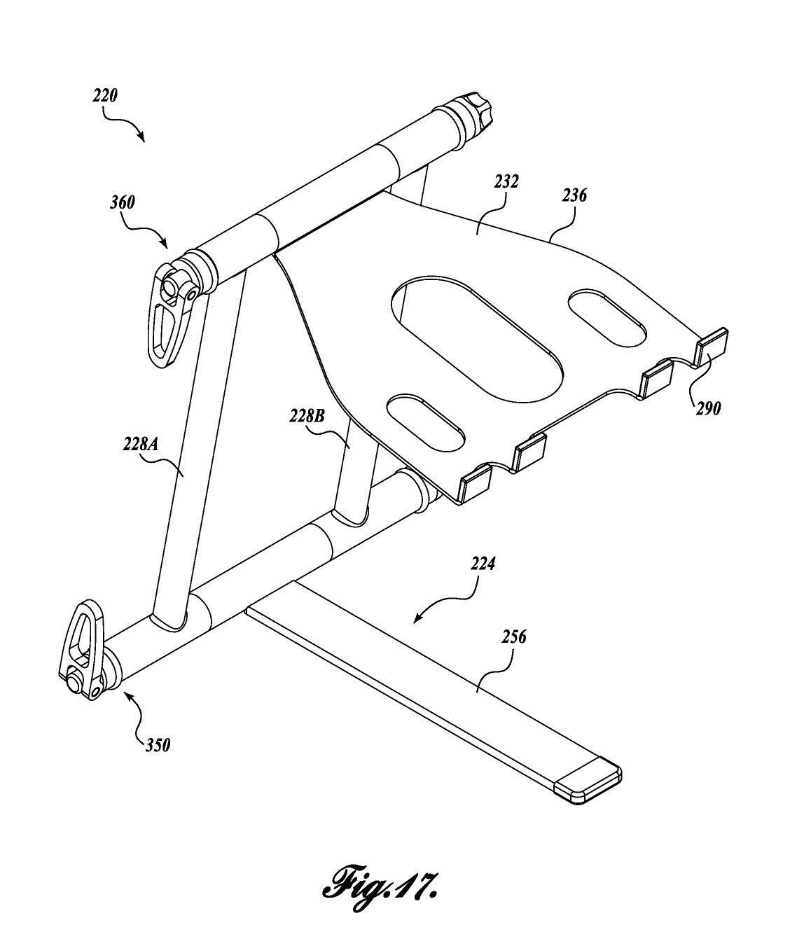

Turning now to FIGS. 1, 2, and 5, the support posts 28A and 28B each have a generally linear body having opposite upper and lower ends 76A and 76B and 78A and 78B. Formed or otherwise coupled to the upper and lower ends 76 and 78 are cross member sections 82A and 82B and 84A and 84B, respectively. The cross member sections 82 and 84 are disposed orthogonally to the at least one support port 28 at a position, for example, that is offset from the midsection of the respective cross member section. In the embodiment shown, the cross member sections 84A and 84B are tubular in shape and are sized to correspond with the cross member section 62. When aligned, the sections 62 and 84A-84B form a continuous tubular member having a cylindrical bore therethrough. The cross member sections 82A and 82B are also tubular in shape and are sized to correspond with the cross member section 88 associated with the tray 36, as will be described in more detail below. In some embodiments, a cross brace 90 may be fixedly secured between the support posts 28A and 28B for added rigidity and the like, as shown best in FIG. 13. The cross brace 90 in one embodiment may include a logo or other indicia, if desired.

Returning now to FIGS. 1-5, the tray 36 will now be described. As best shown in FIGS. 2 and 5, the tray 36 defines a support surface 32. The support surface 32 may take one of a plurality of shapes and sizes, depending on the attended application (e.g., supporting a book, laptop computer, etc.). Additionally, the tray 36 is constructed of a suitable material of an appropriate thickness to provide the support surface with suitable rigidity for its attended application. At the rearward end 92 of the tray 36, one or more stops 94 may be optionally provided. The one or more stops 94 may be disposed anywhere along the rearward end of the tray 36 for forming a stop mechanism. Additionally or alternatively, one or more textured or non-slip sections 96 may be coated, bonded or otherwise attached to the support surface 32 so as to assist in maintaining the object on the tray 36, as shown best in the embodiment of FIG. 12. At the frontward edge 98 of the tray 36 there is coupled or otherwise formed the cross member section 88 (FIG. 4). In the embodiment shown, the cross member section 88 is tubular in shape and includes a plurality of pairs of aligned holes 150, 152, and 154, for reasons for which will be described in more detail below. The cross member section 88 is sized to correspond with the cross member sections 82A-82B of the support posts 28A and 28B. When aligned, the sections 82A-82B and 88 form a continuous tubular member having a cylindrical bore therethrough.

To provide a foldable or collapsible stand, the base 24 and the tray 36 are pivotally coupled to the at least one support post 28. In that regard, the cross member sections 84A, 84B, and 62 form a lower hinge assembly 108 in conjunction with a lower cylindrical rod 112. Similarly, cross member sections 82A, 82B, and 88 form an upper hinge assembly 116 in conjunction with an upper cylinder rod 118. The lower and upper rods 112 and 118 are sized to be received in a supported manner, as best shown in FIG. 5. In one embodiment, caps 120 or other suitable structure may be coupled to the outward ends of the cross member sections 82A-82B and 84A-84B for aesthetical purposes and/or to prevent dirt, debris and the like from entering the interior of the tubular members. Once assembled, the base 24 and the tray 36 are free to rotate with respect to the support posts 28A and 28B about fixed axes defined by rods 112 and 118, respectively. In other words, pin/barrel type hinges are formed between the support posts 28 and the base 24 and tray 36.

In several embodiments of the present disclosure, the base 24 is capable of pivoting with respect to the support post 28 between a number of fixed positions in a selectively adjustable manner. For example, the base 24 is capable of pivoting between the erect position shown in FIG. 1 and the folded position shown in FIG. 3. This allows the base 24 to fold or collapse with respect to the support post 28 into a compact configuration for storage, transport, etc.

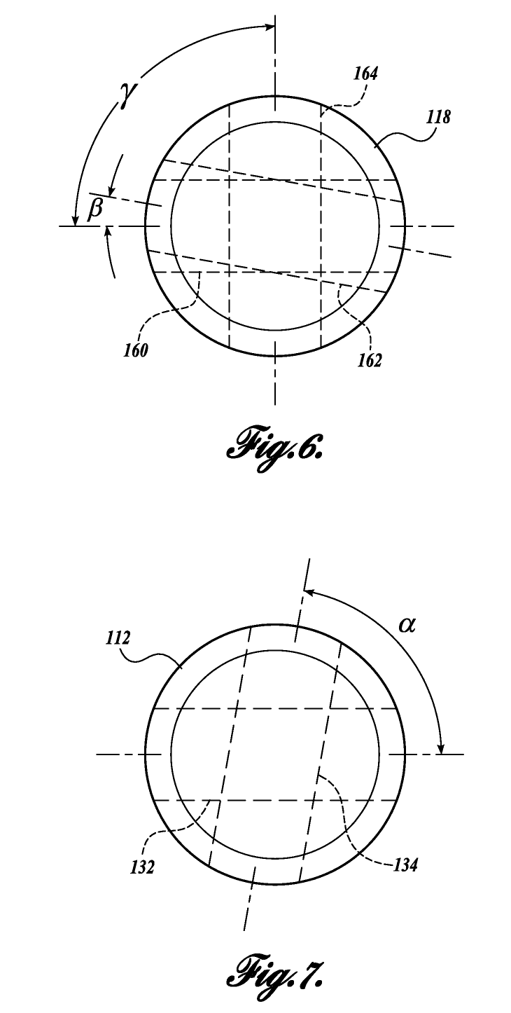

In order for the base 24 to be rotated with respect to the support posts 28A and 28B between two (2) fixed positions, an adjustment mechanism, generally denoted 128, may be employed. In the embodiment shown in FIGS. 2 and 5, the adjustment mechanism 128 has a pin/hole configuration. In that regard, the lower cylindrical rod 112 may include two or more bores 132 and 134 extending laterally through the rod 112 for cooperating with the holes 64 and 66 of the cross member section 62, as best shown in FIG. 5. The bores 132 and 134 are longitudinally positioned such that when the rod 112 has been inserted, the bores 132 and 134 longitudinally align with the holes 64 and 66, respectively. Additionally, the bores 132 and 134 are oriented at an angle α to one another as shown best in FIG. 7.

The orientation of the bores 132 and 134 define the folded and erect positions. In that regard, the holes 66 align with the bore 134 when the base is in the folded position. In one example of the folded position, the leg 56 is substantially parallel with the support posts 28A and 28B (FIGS. 3 and 4). Similarly, the orientation of the bore 132 is such so as to be aligned with the holes 64 when the base is in the erect position. In one example of the erect position, the support posts 28A and 28B are disposed at an angle α with respect to the base 24 (FIGS. 1 and 2). For example, in several embodiments, the angle α is an acute angle in the range of, for example, about 60-85 degrees. In other embodiments, the angle between the base 24 and the support posts 28 may be in a range such that the angle is no longer acute but may instead be at a right angle or slightly obtuse (e.g., 60-110 degrees or more).

A pin 140 can be inserted into the aligned holes/bore so as to fix the position of the base 24 with respect to the support posts 28A and 28B. It will be appreciated that other adjustment mechanisms may be alternatively employed that allow the base to pivot between two defined and fixed positions: the folded position and the erect position. Additionally, it will be appreciated that additional fixed positions may be included, if desired.

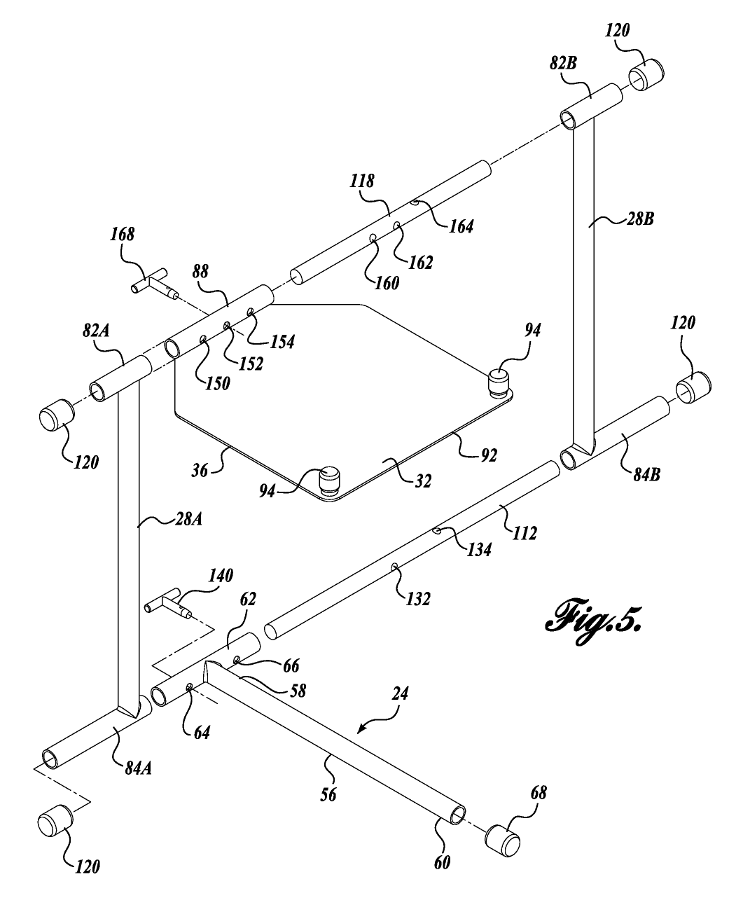

As briefly described above, the tray 36 may also pivot with respect to the support posts 28 between a plurality of fixed positions in a selectably adjustable manner. This allows the tray 36 to provide the user with several ergonomic positions for supporting a laptop, book, etc. The selective adjustment of the tray 36 may be provided by an adjustment mechanism, generally denoted 160 (FIG. 1). In one embodiment, the adjustment mechanism has a pins/hole configuration similarly constructed as the adjustment mechanism 128 discussed above. As best shown in FIG. 5, the upper cylindrical rod defines a plurality of bores 160, 162, and 164 which cooperates with the pairs of holes 150, 152, and 154 of the section 88. The bores 160, 162, and 164 are longitudinally positioned such that when the rod 118 has been inserted, the bores 160, 162, and 164 longitudinally align with the holes 150, 152, and 154, respectively. Additionally, the bores 160 and 162 are oriented at an angle β to one another and bores 160 and 164 are oriented at an angle γ to one another as shown best in FIG. 6. In one embodiment, the angle β is approximately ten degrees and the angle γ is approximately 90 degrees.

A pin 168 can be inserted into the aligned holes/bore so as to fix the position of the tray 24 with respect to the support posts 28A and 28B, for example, in the positions shown in FIGS. 8-10. It will be appreciated that other adjustment mechanisms may be alternatively employed that allow the base to pivot between three defined and fixed positions. Additionally, it will be appreciated that additional fixed positions may be included, if desired.

Referring now to FIGS. 11 and 12, the tray 36 may optionally telescopically extend from the at least one support post 28 between a plurality of fixed positions in a selectively adjustable manner so as to alter the height of the support surface 32 with respect to the surface S, such as the floor, table, etc. In that regard, instead of the cross member sections 82A and 82B being fixedly coupled to the support posts 28A and 28B, the cross member sections 82A and 82B are coupled to the ends of tubular members 170A and 170B. The tubular members 170 include a plurality of aligned pairs of holes 172, 174, 176 and so on. In this embodiment, the support posts 28 are tubular in shape and are sized for receiving the tubular members 170 in a telescopic manner. The support posts 28 further include an aligned pair of holes 180 that cooperate with the pairs of holes 172-176 of the tubular members 170 for providing a number of incremental height adjustments. The distance between the pairs of holes 172-176 may be constant or variable, as desired. A pin 182 can be inserted into the aligned holes so as to fix the height of the tray 36 with respect to the surface S.

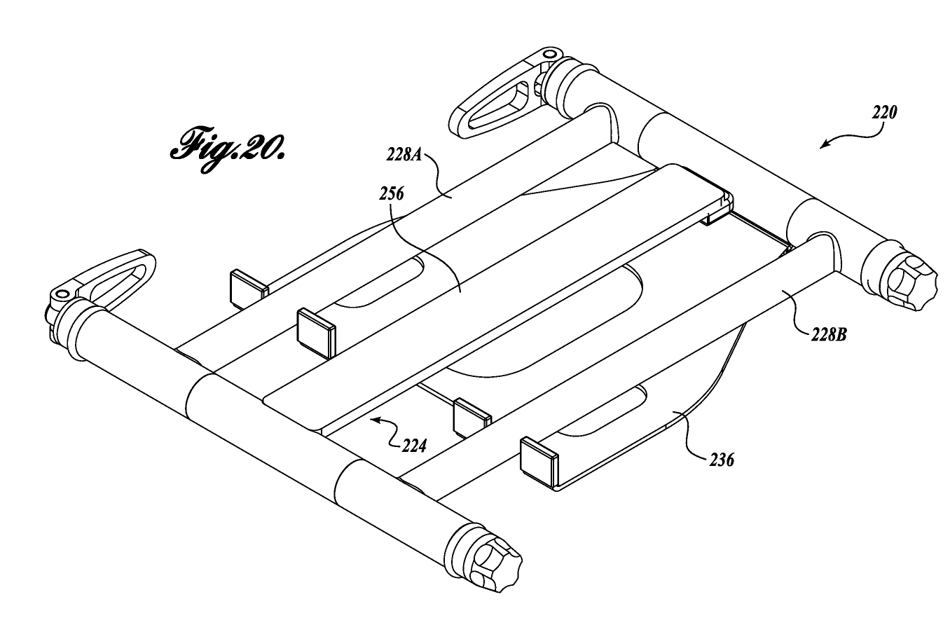

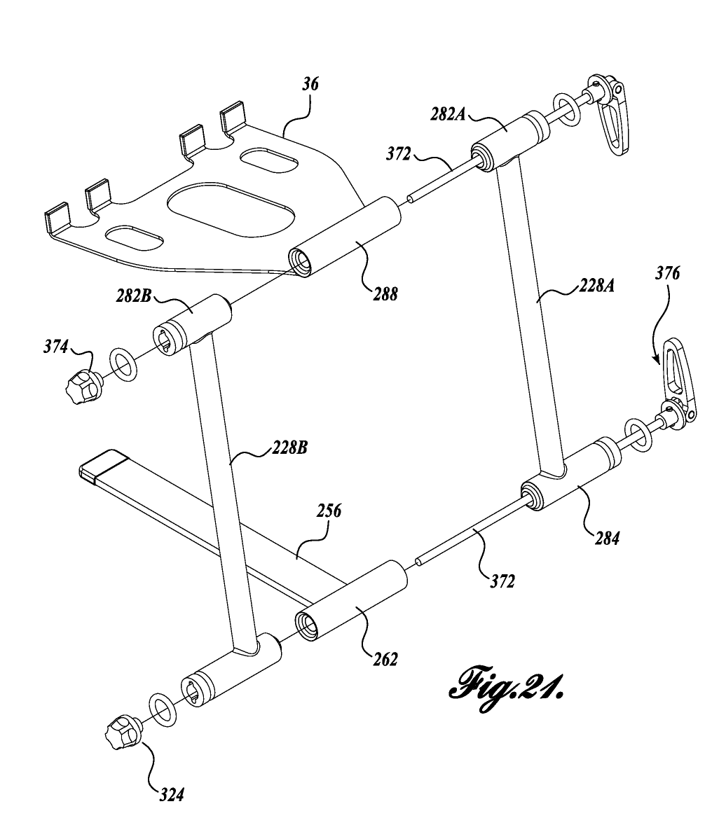

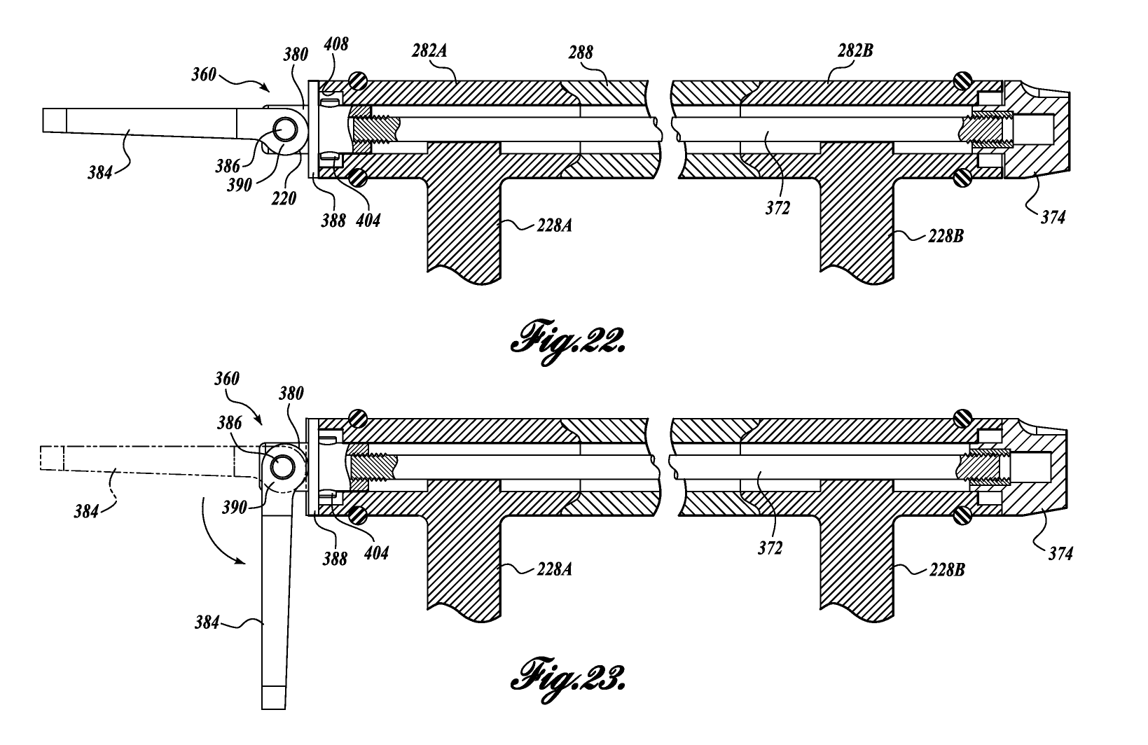

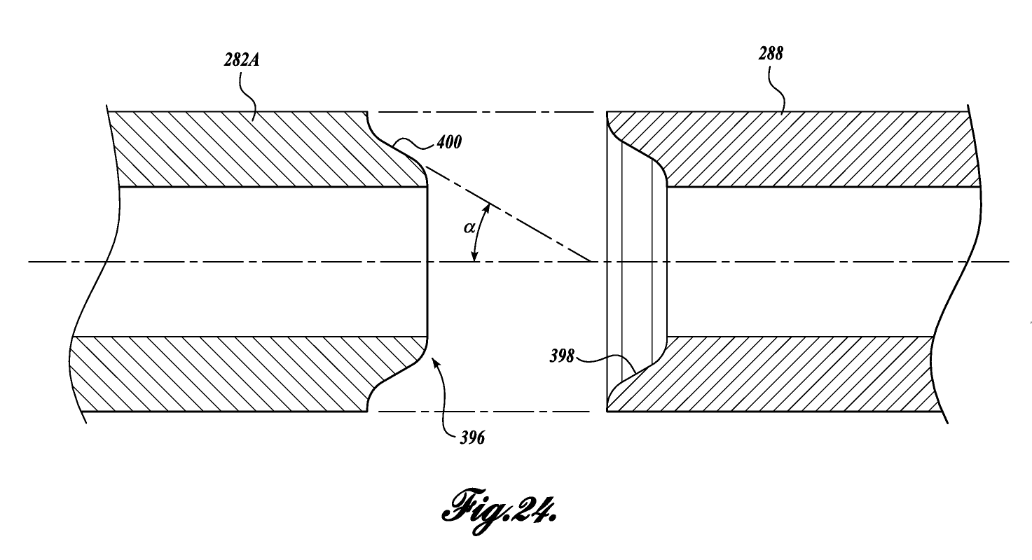

FIGS. 17-24 illustrate another example of a foldable stand 220 formed in accordance with aspects of the present disclosure. The stand 220 is substantially similar in construction and operation as the foldable stand 20 except for the differences that will now be described. As best shown in FIG. 17, the base 224 is formed as a plate member 256. Additionally, the stops 290 are formed as finger like tabs that extend upwardly at an angle from the support surface 232. In several embodiments, the angle is approximately 90 degrees, while in other embodiments, the angle is between 25 and 110 degrees. In will be appreciated that any angle may be used so long as the stops 290 are positioned to arrest rearward movement of the object supported by the tray 236.

Further, the orientation of the base 224 and the tray 236 with respect to the support posts 228 may be selectively adjusted in a continuous and non-index manner. The selective adjustment of the base 224 and tray 236 may be provided by adjustment mechanisms, generally denoted 350 and 360, respectively. The adjustment mechanisms 350 and 360, allow the base 224 and the tray 236 to adjust their orientation with respect to the support posts 228A and 228B in a continuous and non-indexed manner. The adjustment mechanisms 350 and 360 are substantially identical in construction and operation. As such, adjustment mechanism 360 will be explained in greater detail for brevity of the disclosure.

In the embodiment shown in FIGS. 17, 18, and 21-24, the adjustment mechanism 360 includes a threaded rod 372 that extends through the continuous bore of the cross member sections 282A-282B and 288, an adjustment nut 374 threadably coupled to one end of the threaded rod 372, and a lever assembly 376 coupled to the opposite end of the threaded rod 372. The lever assembly 376 includes a cylindrical boss 380, a lever 384 pivotally coupled to the outer end of the boss 380 about pin 386, and a plate member 388 disposed around the boss 380 and in abutment with the cross member 282A. The lever 384 includes a cam 390 disposed at the pivotally coupled end of the lever 384. The cam 390 defines a circumferential cam surface section 392 that has an axis that is offset from the pivot access defined by the pin 386. As such, pivoting the lever 384 pulls the boss 280 in a direction opposite of the adjustment knob 374.

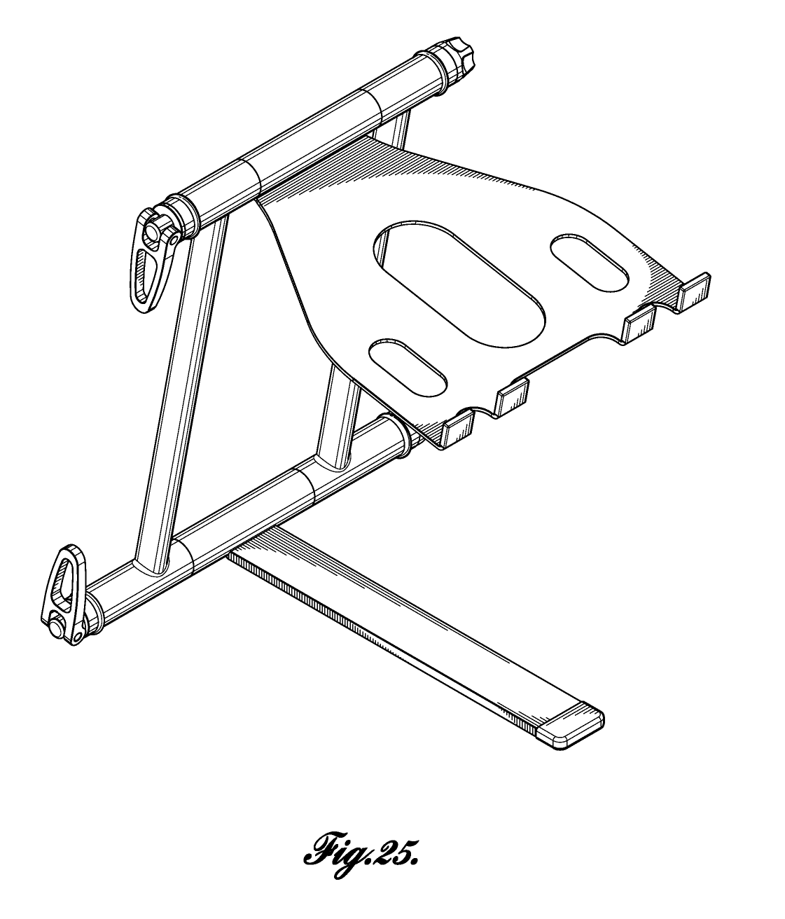

In use, in order to move the tray 236 to another desired position, the lever 384 is moved to its unlocked position, as best shown in FIG. 22. The tray 236 may then be free to pivot with respect to the support posts 228 to the desired position. Once the tray 236 has attained the desired position, the lever 384 is moved to the locked position shown in FIG. 23, thereby fixing the position of the tray 236. As the lever 384 moves from the unlocked position to the locked position, the cam surface 392 abuts against the plate member 388. As the cam surface 392 contacts the plate member 288, the boss 280, the rod 372, and the adjustment knob 374 are together moved in the direction of the lever 384. As a result, the cooperating clamping surfaces 396 and 398 of the cross member sections engage in a tightly clamped manner. It will be appreciated that the adjustment mechanisms 350 and 360 function similar to the quick release lever assemblies employed in the bicycle industry.

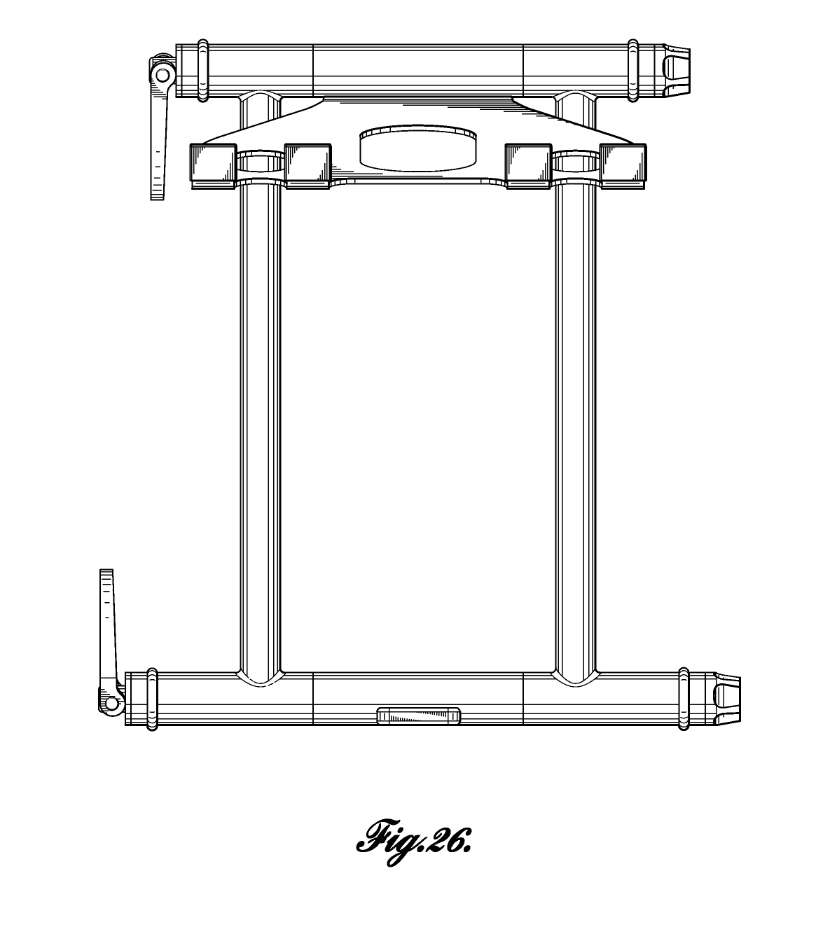

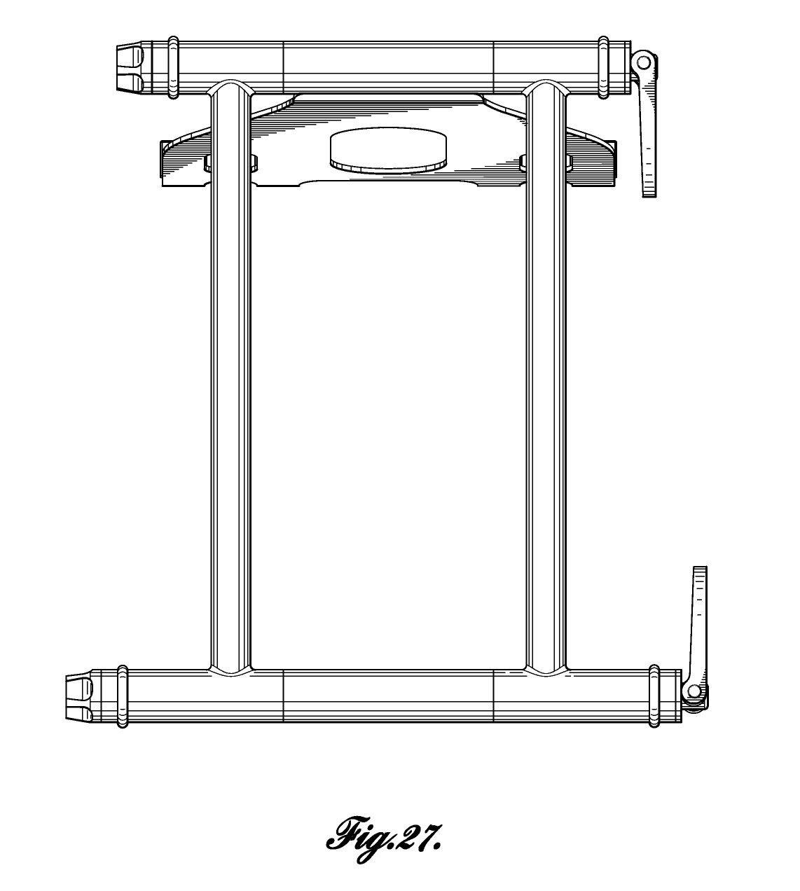

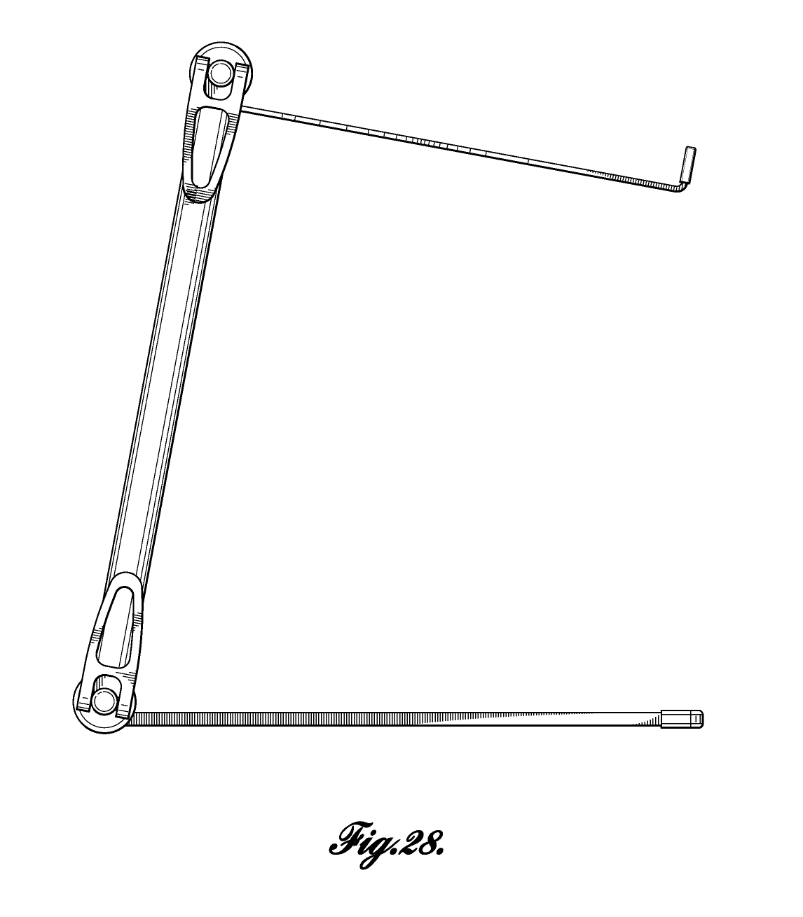

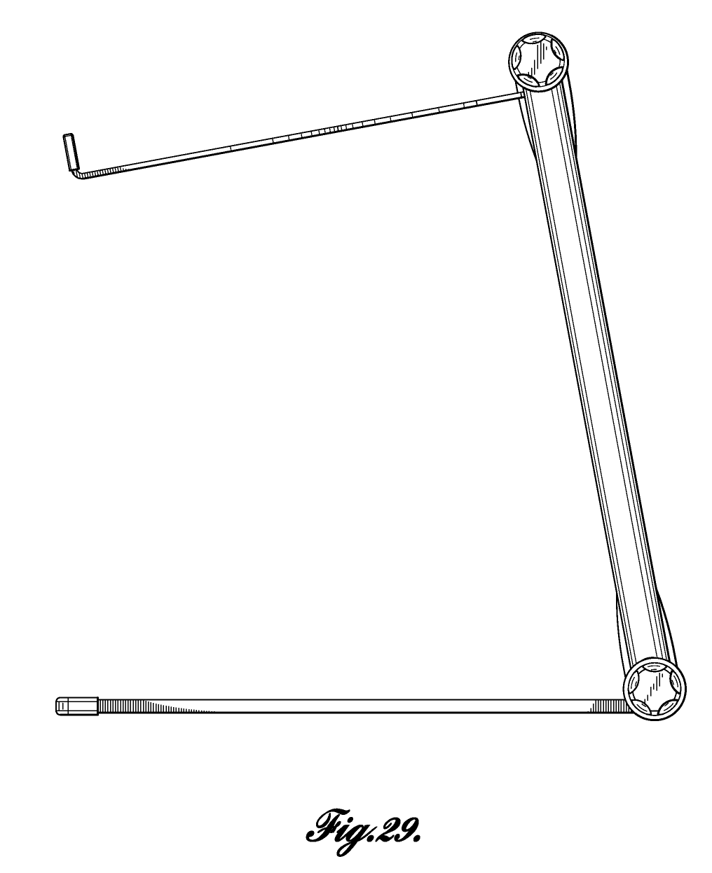

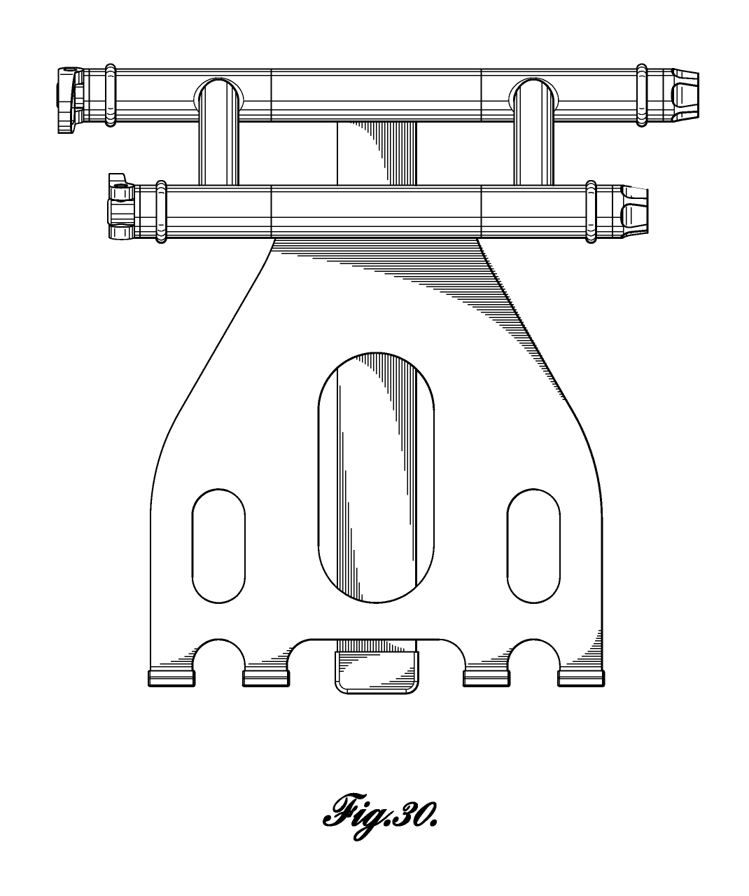

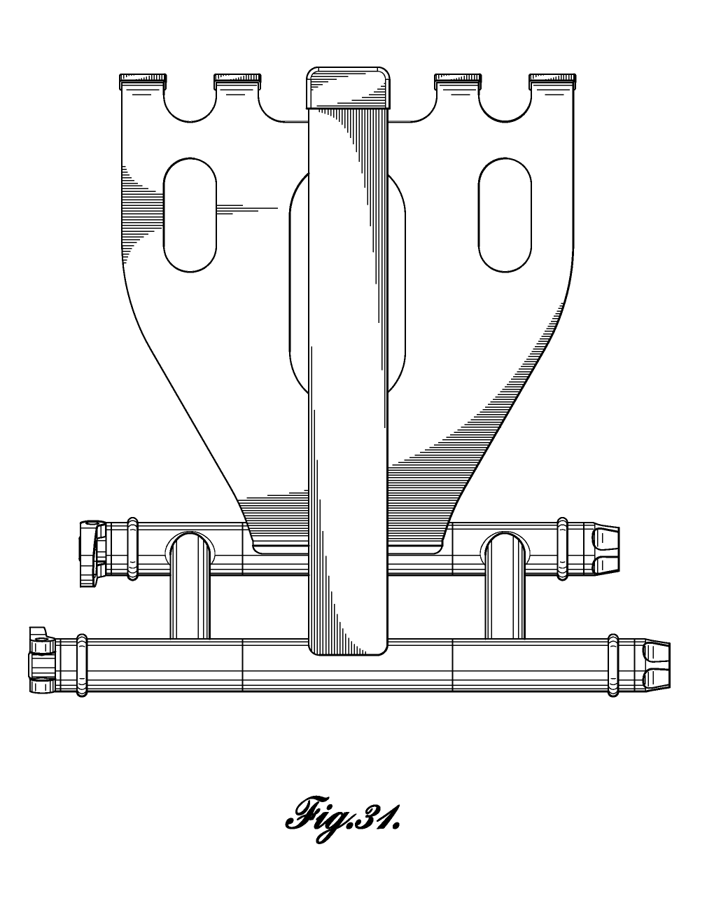

One embodiment of the cooperating clamping surfaces will now be described in more detail. As best shown in FIGS. 22-24, the cooperating clamping surfaces include a convex, somewhat frustoconical shaped surface 396 with radiused corners defined at the inwardly facing ends of the cross member sections 282A and 282B and concave surfaces 398 of cooperating configuration defined at the ends of the cross member section 288. In one embodiment, the tapering side surface 400 formed by the frusto-conically shaped surface is disposed at an angle approximately 30 degrees with respect to the longitudinal axis of the cross member section 288, as best shown in FIG. 24, although other angles may be employed. The convex, frustoconical clamping surfaces 396 cooperatingly engage clamping surfaces 398 of the cross member section 288 when the lever 384 is in the locked position. In one embodiment, the concave clamping surfaces 398 may be slightly smaller than the convex clamping surfaces 396 in order to provide increased frictional resistance against relative rotation of the support posts and the tray. In several embodiments, the clamping surfaces 396 and 398 may also provide rotational support of the tray 236 as it rotates with respect to the support posts 228A and 228B.

The position of the adjustment knob 374 with respect to the threaded rod 372 may be threadably adjusted in order to adjust the clamping force. In order to restrict rotation of the rod 372, a pin 404 may be laterally coupled to the boss 380 and loosely seated within a keyed opening 408 formed in the outward end of the cross member section 282A. Additionally, surface area of the clamping surfaces 396 and 398 may be enlarged to increase the rotational resistance between the support ports 228 and the tray 236 (and base 224).

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A foldable stand having a folded position and at least one erect position, comprising:
at least one support post having opposed ends;
a support defining a support surface; the support pivotally coupled to the at least one support post at one end;
a base pivotally coupled to the at least one support post at the end opposite of the support.

2. The foldable stand of claim 1, wherein the base is pivotally coupled to the at least one support post in a selectively adjustable manner.

3. The foldable stand of claim 1, wherein the base is movable between a plurality of fixed positions.

4. The foldable stand of claim 3, wherein the fixed positions are indexed.

5. The foldable stand of claim 3, wherein the plurality of fixed positions are continuous between a beginning position and an ending position.

6. The foldable stand of claim 5, wherein the beginning position is the erect position and the ending position is the folded position.

7. The foldable stand of claim 1, wherein the base pivots with respect to the at least one support post between the folded position and the at least one erect position.

8. (canceled)

9. The foldable stand of claim 1, wherein the support is pivotally coupled to the at least one support post in a selectively adjustable manner.

10. The foldable stand of claim 1, wherein the support is movable between a plurality of fixed positions.

11. The foldable stand of claim 8, wherein the fixed positions are indexed.

12. The foldable stand of claim 8, wherein the plurality of fixed positions are continuous between a beginning position and an ending position.

13. The foldable stand of claim 12, wherein the beginning position is the erect position and the ending position is the folded position.

14. The foldable stand of claim 1, further comprising a first clamping interface between the support post and the base, the clamping interface having an open position that provides movement between the support post and the base and a clamped position that prohibits movement between the support post and the base; and
a first actuator that that moves the base with respect to the support post between the open position and the clamped position.

15. The foldable stand of claim 14, further comprising a second clamping interface between the support post and the support, the clamping interface having an open position that provides movement between the support post and the support and a clamped position that prohibits movement between the support post and the support; and
a second actuator that that moves the base with respect to the support post between the open position and the clamped position.

16. (canceled)

17. The foldable stand of claim 15, wherein the first or second clamping interface includes a frusto conical clamping surface.

18. The foldable stand of claim 17, wherein the frusto conical clamping surface defines a tapering side surface that is oriented at an angle of approximately 30 degrees with respect to the longitudinal axis of a section of the support post.

19. The foldable stand of claim 15, wherein the first or second actuator includes a quick release lever.

20. The foldable stand of claim 1, wherein the support is telescopingly extendible from the at least one support post.

21-22. (canceled)

23. A foldable stand comprising:
a support surface;
a base;
at least one support post;
means for pivotally coupling the at least one support post to the base;
means for pivotally coupling the support surface to the at least one support post.

24. A foldable stand comprising:
a support surface;
a base;
at least one support post pivotally coupled to the base and the support surface in a selectively adjustable manner.

25-27. (canceled)
